(19) United States
(12) Patent Application Publication
(10) Pub. No.: US 2008/0172325 A1
(43) Pub. Date: Jul. 17, 2008

(54) Optimal reverse mortgage product and methods, systems, and products for providing same

(76) Inventors: Jeffrey Scott Lange, New York, NY (US); Jeffrey M. Lewis, New York, NY (US)

Correspondence Address: Mr. Jeffrey S. Lange, 211 E. 70th St. Apt. 32H, New York, NY, 10019, US

(21) Appl. No.: 11/653,451

(22) Filed: Jan. 16, 2007

(51) Int. Cl. G06Q 40/00

(52) U.S. Cl. 705/38

(57) ABSTRACT

This invention provides systems, methods, and designs for a novel financial product which provides many lifecycle investment advantages compared to existing state of the art products currently available.

### FIELD OF THE INVENTION

The present invention relates generally to systems, methods, plans and products for designing and providing financial products which are both investment, consumption, and tax efficient across the lifecycle of an individual. In the theory of financial economics, lifecycle investing and consumption involves systematic investment and consumption planning throughout an individual's entire lifecycle in order to help best achieve one's financial objectives and goals. According to the well known Lifecycle Investment Theory of Nobel laureate Franco Modigliani, every individual passes through distinct stages in his lifecycle which are defined by characteristic and differing marginal utilities for saving and consumption. The first characteristic stage is the accumulation phase, during which an individual has higher marginal utility for consumption but constrained or limited resources. This phase is marked by dissaving by the individual, as he spends more by way of loans than he earns to meet his multiple needs. The second characteristic phase in an individual's lifecycle is the consolidation phase wherein the individual has satisfied most of his essential needs and is looking at opportunities of incremental wealth generation. This phase is marked by a higher marginal utility of wealth currently or, in other words, an intertemporal substitution of consumption whereby deferred consumption is deemed to have higher utility. In this stage, individuals typically exhibit net saving. The third and fourth phases are often referred to as the spending and gifting stages, respectively. These phases are again marked by dissaving as an individual eats into his earlier savings to meet up with his remaining lifecycle. As an individual evolves through these stages in his lifecycle, not only do his financial objectives and goals change, but also his risk bearing ability, which largely determines the feasible set of investment choices at each stage. The aim of the present invention is to provide novel methods, systems and products for lifecycle investment and consumption which efficiently achieve these changing investment goals. Throughout the description of this invention the term efficiency includes both market or pure investment efficiency which is a function of the expected returns and volatilities of the feasible set of investment choices, and tax efficiency, which refers to providing investment methods, systems, and products which produce a large after-tax source of wealth under the U.S. Internal Revenue Code.

### BACKGROUND OF THE INVENTION

A number of uses for life insurance products have emerged in recent years to fulfill many lifecycle investment objectives. Various types of life insurance and annuity products have a dual savings and bequest objective which reflect the demand for deferred consumption in one's own lifetime and for the lifetime of one's beneficiaries. Recent innovations, such as variable universal life (VUL) insurance, bundle investment accounts together with yearly renewable term insurance. In this product, individuals may invest in a range of securities, mutual funds, or other types of investment partnerships in segregated investment accounts. The accounts are nominally owned by the issuing life insurance company. As a consequence, the owner of a variable universal life insurance policy pays no current income tax on investment returns. The death benefit of a VUL policy will generally increase as positive investment returns are accumulated. If the individual dies, this increased death benefit is paid out free of income tax to the VUL policy's beneficiaries. If the owner of the policy makes a withdrawal from the VUL policy prior to death, ordinary income tax is due on any earnings in the policy. Thus, a VUL policy bundles together the following components: (1) tax preferred growth of assets for either the individual (tax deferred withdrawals) or the individual's beneficiaries (tax free death benefits); (2) a layer of yearly renewable term insurance which is responsive to the overall growth in the investment accounts; (3) a mechanism by which the layer of term insurance can be paid for with before tax dollars through automatic deductions in the investment accounts.

A VUL policy is therefore a bundle of what financial economists call contingent claims. A pure contingent claim is a non-interest bearing security which pays out a unit of account (i.e., a dollar) should a given state of the world occur. For example, pure term life insurance pays out a certain quantity of dollars upon the death of an individual. Financial economists generally recognize that it is preferable to have a complete set of elementary (i.e., unbundles) contingent claims from which individuals can choose to fulfill their lifecycle investment objectives. (See, e.g., Lange and Economides, “A Parimutuel Market Microstructure for Contingent Claims,” European Financial Management, vol. 11:1, January 2005, and references cited therein). It is also generally recognized that bundling of contingent claims is generally a redundant exercise, however, bundling may be advantageous due to transaction cost and tax efficiency. For example, a VUL policy is a bundling of a tax deferred investment account and a term life insurance policy. An individual might be able to achieve the same objectives satisfied by a VUL policy by investing in a tax deferred 401(k) account and buying yearly renewable term insurance. Prima facie, the combination of the 401 (k) and the term insurance appears to achieve the same objectives as the VUL policy: tax free accumulation of investment returns available for withdrawal at a future date and an income tax free death benefit for beneficiaries. However, the VUL policy dominates for two reasons. First, were an individual to attempt to replicate a VUL policy with a 401(k) account and yearly renewable term insurance, they would find that the premiums paid on the term insurance must be made from after tax dollars. Section 264 of the Internal Revenue Code provides that these premiums are not tax deductible. In the VUL policy, by contrast, the premiums which keep the insurance portion of the VUL policy in force are automatically deducted on a monthly basis from the investment account. To the extent the investment account has returns, the premiums for the insurance are paid with pre-tax dollars since the returns from the VUL policy investment accounts accrue free of income tax. Second, replicating the VUL policy with a 401(k) and yearly renewable term insurance will incur significant transaction costs as the individual must dynamically “rebalance” the ratio of the balance in the 401 (k) versus the amount of term insurance. The VUL policy does this type of rebalancing automatically according to well-known and relatively efficient procedures. There is, however, a cost to bundling in the VUL policy: the Internal Revenue Code requires a minimum ratio of insurance to the balance in the VUL investment account in order for the VUL policy to meet the definition of insurance under Title 26, Section 7702. If this minimum ratio is requirement is not met, then the investment account returns will not receive the benefit of tax-free accumulation and the death benefit will be free from income tax.

In the spending and gifting phases of the lifecycle investment theory, an individual would typically optimally reduce his exposure to the riskiest of asset classes and, at some later point in his lifecycle, begin to annuitize a large portion of his wealth. The portion of assets exposed to risky assets classes, the level of such risk, the amount of wealth annuitized largely depend upon the individual's utility for current consumption and his utility for estate preservation—what economists typically call a “bequest motive” since it refers to a utility function “beyond the grave” to preserve assets for the next generation via bequest (or, equivalently, gifts late in an individual's lifetime). While a VUL policy can allow an individual to reallocate away from risk assets at this state in life and also annuitize part of his wealth, a VUL product's death benefit and the performance of its underlying investments are highly correlated. That is, if the segregated account assets of a VUL policy fail to perform adequately, there may not be sufficient funds in the VUL policy to keep the death benefit in force through ongoing payments of the policy's cost of insurance. Additionally, variable annuities—both deferred and immediate—suffer from the same drawbacks. Investment performance is uncertain, thereby exposing the individual to both consumption and bequest risk. Non-variable immediate annuities, which bear substantial interest rate risk for the individual, also suffer from the imposition of a relatively high rate of immediate and deferred taxation. Through the expected lifespan of an individual a substantial portion of these fixed immediate annuities (SPIAs) are taxed. After the individual reaches his expected lifespan, the entire annuity payment is taxed.

As the portion of the population in the United States aged 65 and older is expected to double to 70 million in the year 2030, there is a growing demographic need to provide funded and tax efficient Long Term Care Insurance (LTC). In 2005, for example, legislation is pending before the U.S. Congress to provide a bundled annuity and LTC product which provides tax favored LTC benefits when such benefits are paid as part of an annuity product.

Another strong demographic trend emerging in the beginning of the 21^{st} century is the large amount of home equity held by persons in the aging demographic. Current estimates of unencumbered home equity held by persons in the United States aged 65 and over range from 1 trillion to 2 trillion dollars. Such wealth is held in illiquid form not amenable to easy conversion into an efficient lifecycle and consumption plan.

A product that has emerged which attempts to convert the vast holdings of older Americans into liquid annuity cashflows is the reverse mortgage (RM). An RM is a non-recourse loan to an individual who owns substantial unencumbered home equity. The loan is provided to the individual against a first mortgage lien on the individual's home. The individual RM borrower can receive loan proceeds in either a lump sum payment, annuity payments for a certain period or for life, or in the form of discretionary payments similar to those that can be obtained with a home equity line of credit (HELOC). All principal and interest payments are due upon the death of the homeowner (or the last surviving homeowner, if applicable and if both homeowners are borrowers under the RM). The individual receives all RM proceeds free of tax. Upon death, the individual's estate receives a tax deduction for interest paid on the RM.

As can be seen in the below graph, RM origination has grown steadily from 2000 to 2004:

The above graph shows the growth in RM loans originated through the FHA Home Equity Conversion (HECM) program.

A number of disadvantages currently inhibit the growth of RM originations and their efficient lifecycle use by individuals. First, the conventional RM is very risky to the lender since the lender bears substantial longevity and real estate value risk. If the individual lives well beyond life expectancy calculated when the RM loan was originated and if home values do not keep appreciating at a reasonably high rate, the lender will not be able to recover all principal and interest due upon the death of the borrower because the RM, unlike conventional mortgage products, is non-recourse. Thus, the loan rate and other fees charged the borrower on existing RM products are very high and have impeded substantial growth. A need therefore exists for a new RM product which a lender an issue at a lower cost to the borrower which, at the same time, addresses the economic risks to the lender in offering the RM at lower cost.

Second, traditional RM products do not address the growing need for LTC insurance, as noted above. While existing RM products do provide liquidity for borrowers to independently purchase LTC insurance, the efficiency of LTC coverage can be enhanced greatly and provided with much less cost when bundles as part of a large lender sponsored RM product. In addition, individuals may not act fully rationally when allocating RM proceeds to other needs and the LTC need may not be addressed at all. Thus, a need exists for a new RM product, and systems and methods therefor, to provide both liquidity for existing stores of home equity and automatic bundled provision of LTC insurance at low cost.

Third, individuals have been reluctant to embrace current costly RM products since such products may, in future weak real estate markets, cannibalize all or most of the individual's home equity. While RM's are designed to effectively annuitize home equity, the risk exists that upon the RM borrower's death that temporary weakness in the borrower's real estate market would force a “fire sale” of the home to cover the accrued RM interest and principal, thereby greatly reducing the borrower's estate and thwarting his bequest motives. A need therefore exists for a new RM product, and systems and methods therefor, which provides the RM borrower a guaranteed and favorable source of liquidity for his home so that the RM loan principal and interest can be paid back to the lender without the risk of a disadvantageous sale of the home by the borrower's estate.

It is therefore an aim of the present invention to provide an RM lifecycle financial product in which (1) an individual can annuitize existing home equity at lower cost (2) receive LTC insurance efficiently bundled with the RM product; (3) provides the RM lender greater collateral security in making the RM loan in order to provide the RM to borrowers at costs lower than currently available and (4) provides a guaranteed source of liquidity to the borrower to repay the RM loan and accrued interest upon death.

For all these reasons and others, there is a need for a new RM financial product which, in a preferred embodiment, has the following characteristics:

(1) a right to receive a lump sum, annuity or discretionary payments from a lender in return for a first mortgage lien with no principal or interest payments due until the death of a selected homeowner, where said interest and other fees on such a loan is lower than that currently available;
(2) a right to receive LTC insurance from the RM lender at no additional cost for the duration of the loan;
(3) a right, but not necessarily the obligation, to sell the home to the lender, or an affiliate of the lender, to sell the home upon the termination of the RM loan at the death of the selected homeowner at an advantageous price (“mortality put on home”);
(4) provides the lender the right to purchase life insurance on the lives of the selected homeowner borrowers, pursuant to the lender's insurable interest as a creditor and obligor on the mortality puts, in order to provide greater collateral security for the lender in order to offer the new RM product at lower cost.

### SUMMARY OF THE INVENTION

The present invention provides methods, systems and products to solve the following problems or deficiencies facing an individual who desires make optimal lifecycle investment and consumption decisions by utilizing home equity and an optimal reverse mortgage loan:
(1) Current RM products are too costly due to borrower moral hazard and lender risk;
(2) Current RM products do not provide a means of efficiently providing LTC insurance;
(3) Current RM products do not provide a source of homeowner liquidity and pose too much risk to homeowner equity;
(4) Current RM products are too risky and costly for lenders.

The aim of the present invention is to solve these problems by providing methods, systems and products which accomplish these investment and insurance objectives.

A need is recognized for a new RM product which is less costly to the borrower. A need is recognized to reduce the overall borrowing cost to the borrower through reduction of RM loan risk to the lender and through reduction of origination costs.

A need is recognized to reduce risk to the lender by having the lender underwrite lender owned life insurance on one or more RM borrowers.

A need is recognized for a new RM product which provides a bundled source of liquidity for the homeowner upon death whereby the homeowner has the right but not necessarily the obligation to sell his home back to the lender upon the death of a specified homeowner.

A need is recognized for an RM product which combines shared home appreciation features to further reduce the interest cost to borrowers.

A need is recognized for a cost efficient bundling of LTC insurance with an RM product in order to satisfy the demand, at efficient cost, for LTC insurance among the population of RM borrowers.

According to one embodiment of the present invention, as described herein, a method, system and product for bundles reverse mortgage product (BRM) comprises the steps of:
1) determining a candidate for the purchase of the BRM based on a plurality of criteria;
2) determining the advance rate for the BRM based upon at least the following criteria: (i) the age of the candidate borrower; (ii) the cost of the bundled LTC insurance; (iii) the current value of the borrower's home; (iv) the expected appreciation of the borrower's home of the borrower's expected life span; (v) the expected lifespan of the borrower; (vi) the cost of providing a bundled liquidity right for the borrower or co-occupant of the home or both to sell the home to the BRM lender at the death of either home occupant; (vii) calculation of the price at which either occupant may sell the home back to the lender upon death; and (viii) obtaining the cost of life insurance on either or both home occupants.
4) obtaining the consent to purchase life insurance on the life of either or both occupants of the home;
5) determining the amount of life insurance to be purchased by the seller to collateralize and hedge the obligations under the BRM as a function of (a) the amount of the advance rate; (b) the loan rate of the BRM; (c) the expected life of the borrower or borrowers; and (d) the purchase price of the bundled home mortality put under the BRM.
6) having the lender of the BRM purchase life insurance upon the life (or lives) of the BRM borrower or borrowers from a plurality of carriers whereby such life insurance may be (a) general account universal life insurance (b) variable universal life insurance (c) term life insurance or (d) other types of life insurance such as whole life insurance;

### BRIEF DESCRIPTION OF THE DRAWINGS

FIG. 1 is a schematic representation of a system, method, and product for the BRM—a bundled reverse mortgage loan comprising (1) a reverse mortgage loan; (2) bundled long term care insurance; (3) a mortality put on the home issued by the lender or an affiliate thereof and (4) lender owned life insurance.

FIG. 2 is a schematic representation of a system, method, and product for the management of a portfolio of life insurance assets used to collateralize or hedge BRM obligations and liabilities.

### DETAILED DESCRIPTION

The present invention is described in relation to systems, methods, products and plans for the enablement of a novel lifecycle financial contract and product. The product, described above and named BRM for the purposes of the present invention, is a novel reverse mortgage product which provides the following benefits: (1) provides the borrower with lifecycle consumption opportunities for the annuitization of stored household wealth in the form of home equity; (2) provides the borrower bundled long term care insurance protection which pays the borrower a defined benefit should the borrower's health decline to the extent the borrower or borrowers would qualify for the LTC benefits; (3) provides the borrower risk management and home equity protection via the bundling of a mortality put on the home of the borrower or borrowers entitling the borrower or other home occupant to sell the home back to the lender upon the death of one or more home occupants at a specified price; (4) provides for life insurance to be originated and owned by the lender so as to provide additional collateral support for the BRM so that same can be offered at more attractive terms to the borrower or borrowers. Additional steps of the methods and systems relating to the offering of the BRM include, but are not limited to the following: (a) obtaining the current value of the home to serve as collateral under the BRM; (b) determination of the actuarial expected life span of the borrower or borrowers under the BRM; (3) selection of an appropriate loan rate under the BRM commensurate with the expected duration of the loan, credit profile of the borrower, quality of the home collateral, interest rate market conditions, and other factors; (4) computation of the BRM loan limit as a function of the expected life span of the borrower or borrowers and credit and collateral related factors; (5) selection of a bundled LTC policy for the borrower or borrowers; (6) determination of the strike price of the mortality put upon the death of the borrower, borrowers, or other home occupants as a function of the current home value, the expected appreciation of the home, the expected life span of the relevant life or lives upon which the mortality put is contingent, the ratio of appraised value to market value of the home and other factors; (7) obtaining the consent of the borrower or borrowers for the lender to obtain life insurance on their respective lives; (8) optimal selection and design of the life insurance to be obtained by the lender, such selection, in a preferred embodiment, to be based upon the age of the insureds, the state in which the insured resides, the type of policy to be purchased, whether the premium is guaranteed or not, the structure of death benefits over time (e.g., whether increasing or not), the timing of premium payments to be made to fund the policy or policies and other factors.

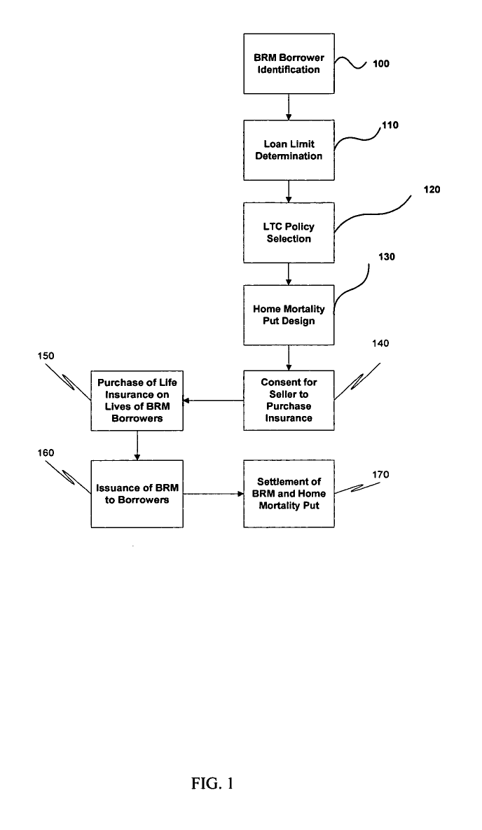

FIG. 1 is a schematic representation of a system and method for the creation of the BRM product, and a schematic illustration of the product itself. The system, method, or product, 100, may comprise the ability to identify suitable borrowers. Suitable purchasers are those that might be of a certain age, insurable status, and have encumbered home equity of a certain threshold amount. For reverse mortgages which conform to FHA or Fannie Mae guidelines (under, for example, the FHA HECM or Fannie Mae Homekeeper programs) borrowers must be at least 62 years of age. For RM's which need not conform to federal standards, a lower age may apply, though typically the BRM will be offered to those aged 62 and older. RM's typically require unencumbered home equity at the time of loan origination, however, it is also possible to refinance existing home debt and at the balance to the newly originated RM provided there is sufficient equity in the home. Additionally, the identification of likely BRM borrowers may include the analysis of prospective borrowers' current portfolio holdings or potential holdings of risky assets, an analysis of their present and future tax liabilities, and their bequest motives for their heirs (i.e., an analysis of their utility function for leaving large amounts of wealth to heirs). Additionally, and in a preferred embodiment, the state in which the BRM borrower may be an important fact in determining the terms on which a BRM may be offered. In particular, and in a preferred embodiment, in order for the lender to purchase life insurance which offers sufficient collateral support to the lender, the borrower/insured should reside in a state in which the lender purchase of life insurance is not onerously regulated by that state's credit life insurance regulations. For example, the following is an excerpt from the relevant California statute with the relevant portions bolded:

Typically, states except life insurance in connection with credit transactions based upon the duration of the loan (e.g., 10 or 15 years), where the insured does not pay for the policy, or where the loan is a first mortgage loan. Thus, for states with these exceptions life insurance originated in connection with RM lending will not be subject to the statutes. Referring again to FIG. 1, step 110 comprises the determination of the BRM loan limit. The determination is a function of, in a preferred embodiment, at least the following factors:
(1) Computing the expected lifespan for the borrower, borrowers, or other home occupants. Where more than one borrower is on the loan, the computation of the expected lifespan, in a preferred embodiment, may be performed on a last to die basis, meaning the expected number of years until the last borrower on the BRM has died;
(2) Determining the current value of the home to be provided as collateral under the BRM. The determination of current home value can be accomplished by appraisal, comparable sales, purchase of research of econometric data from firms such as Case Shiller Weiss, and other methods of home value estimation known in the art;
(3) The cost of the LTC insurance selected pursuant to step 120 of FIG. 1;
(4) Whether the loan proceeds of the BRM are to be received in the form of annuity cashflows for the lives of the borrowers, a lump sum payment, or as a line of credit providing for discretionary draws by the borrowers;
(5) The interest rate on the loan, whether fixed of floating, the spread to fixed to floating rates as a function of the credit risk of the loan and market conditions; and
(6) The cost of private mortgage insurance (PMI) if necessary or required.

As an example of the loan limit determination, the following assumptions and calculations, in a preferred embodiment example:

| | |
|---|---|
| Age of Male Homeowner and Spouse: | 74 and 70, respectively |
| Home Value, Spot: | $500,000 |
| Assumed RM Rate: | 7% (approximately 3M LIBOR + 300 bps), assumed |
| | constant through life expectancy |
| Life Expectancy: | 17 year (for both homeowners) |
| Assumed Home Appreciation: | 4%, per annum (in line with Fannie Mae assumptions) |
| Assumed Assessed/Market Value Ratio: | 70% |
| Forward Assessed Value Liquidity Right: | $682,000 at LE |
| Life Insurance Death Benefit: | $682,000 per homeowner |
| LTV: | 100% of Spot Collateral Value |
| RM Proceeds: | $158,287 |
| LTC Benefit: | $1,500 per month for each spouse |
| LTC Benefit Period: | 2 years |
| Elimination Period: | 180 days |
| Total LTC Cost: | $1,077 per annum, Life Pay, covers both spouses |
| Home Assessment Frequency: | 5 years |
| NPV Assessed Value Put Right¹: | 43 basis points ($2,150), assuming 12% volatility |

¹We use the following assumptions. The empirical ratio of assessed value to market value has an upper end range of 70%. Some states actually codify 70%, e.g., Connecticut. We use a 5 year assessment frequency which we think is conservative given that some states, such as California, have an average reset period which is much longer (California has much lower assessed value to market value ratios, in part due to the legacy effect of 1978's Proposition 13 and also due to caps on assessment increases equal to 2% annually. For example, at the last market cycle peak in 1991, the ratio in Los Angeles County was approximately 20%. During the market sell-off to the 1996 trough, the ratio increased to 26% reflecting property value decreases of up to 30%. In any event, average ratios were quite low. We price the Assessed Value Put Right as a strip of forward starting options which reset at 70% of the forward price every 5 years through life expectancy.

In the above example, the loan limit of $158,287 is the amount, which, when compounded annually at the loan rate of 7% to the life expectancy of each borrower, grows to the current home value of $500,000. Alternatively, a second to die lifespan longer than 17 years could have been used which would have resulted in a lower loan rate. Different combinations of these principles, as is apparent to one skilled in the art, will lead to different loan limits.

Referring again to FIG. 1, step 120 is the method step of selecting an LTC policy for bundling to the BRM. For example, in the above preferred embodiment example, an LTC policy provided by John Hancock was selected. The LTC policy provides for $1,500 a month should each spouse's health qualify under the policy for benefits. The total benefit period is 2 years. The cost of the policy to be bundled at no cost in the BRM loan is $1,077 to the lender.

Referring again to FIG. 1, method step 130 if the design of the home mortality put, giving the borrower, or other home occupant, or the estate of the borrower, to sell the home back to the lender upon the death of the borrower, co-borrower, or other home occupant at the time of the respective death of each person. For example, referring again the to the above example, the home mortality put, in a preferred embodiment, may give the right of the 70 year old male borrower or the 74 year old female borrower the right to sell the home back to the BRM lender at the death of either borrower at 70% of the home's then appraised value. In another embodiment, the event triggering the home mortality put may be the death of only a single borrower, or it could be triggered by 2, 3 more home occupants or borrowers. Additionally, and in a preferred embodiment, the “strike price” or price at which the lender is obligated to buy back the home at the election of the borrower's estate may be set in a variety of different ways. For example, the strike price might be set at the time of the BRM loan origination as a fixed dollar amount.

Referring again to FIG. 1, step 140 is the procurement of consent from the BRM borrower or borrowers for the lender to purchase life insurance on the respective lives of the BRM borrowers (or other home occupants if such occupants are not borrowers but reference lives under the home mortality puts). The lender has an insurable interest in the borrower or borrowers (or other home occupants) under a plurality of separate legal principles. First, as a lender, state statutes generally recognize a creditor's insurable interest in a debtor. Second, since the lender has entered into an agreement whereby the lender has the obligation to buy back the property upon the death of one or more individuals, the lender suffers a financial loss or obligation upon the death of such individuals. State statutes also recognize these set of circumstances as giving rise to an insurable interest. Irrespective of the legal foundation for insurable interest, the insured or insureds under a validly originated life insurance policy must consent to the issuance of such insurance. In a preferred embodiment, such consent will contain at least the following: (a) an acknowledgement by the insured of the purpose of the insurance; (b) an acknowledgement that the insured or insureds will not receive any benefits under the insurance policy; and (c) an acknowledgement that the procurement of such insurance may impair the ability of the insured or insureds to obtain life insurance in the future.

Referring again to FIG. 1, step 150 provides for the actual selection and purchase of the life insurance on the lives of the BRM borrowers (or reference lives under the home mortality put). In a preferred embodiment, such life insurance will have the following characteristics: (1) a fixed universal life insurance policy structure (“fixed UL”); (2) no-lapse guaranteed premiums; and (3) a return of premium rider. In other preferred embodiments, variable universal life insurance, term insurance, or other types of life insurance with different structures may be used.

Referring again to FIG. 1, step 160 is the step of actual issuance of the BRM to the BRM borrowers. This step, in a preferred embodiment comprises the following: (1) Procurement of warehouse funding by the BRM borrower; (2) providing, in a preferred embodiment, for the purchase of the issued BRM loan by a REMIC conduit, commercial bank, REIT, or other financial intermediary; (3) obtaining of a first mortgage lien and recordation of a UCC-1 financing statement or similar evidence of indebtedness on the home of the borrower; (4) arranging for the closing of the loan; and (5) advancing the BRM loan proceeds and provision of the certificate of LTC insurance to the BRM borrower.

Referring again to FIG. 1, step 170 comprises the settlement of the BRM loan upon the death of the borrower or borrowers and, if applicable, the settlement of the home mortality put. Upon the death of the borrower, or the last surviving borrower (or in other embodiments, the specified death of a borrower), the heirs of the borrower may sell the home subject to the BRM. As already specified, the BRM is a non-recourse loan so the loan amount due at the time of the specified death can only be satisfied out of the sale of the home. In a preferred embodiment then, settlement may occur per step 170 of FIG. 1 by having the heirs of the borrower put the home up for sale. Settlement may also occur by the heirs of the borrower (or other specified decedent) exercising the home mortality put right. In this instance, the heirs will provide written notice to the lender (e.g., 30 days' notice) that the heirs have elected to exercise their right to sell the home back to the lender pursuant to the bundled home mortality put. In a preferred embodiment, the lender will receive the funds from the life insurance policy to discharge the obligation to buy the home under the implied mortality put.

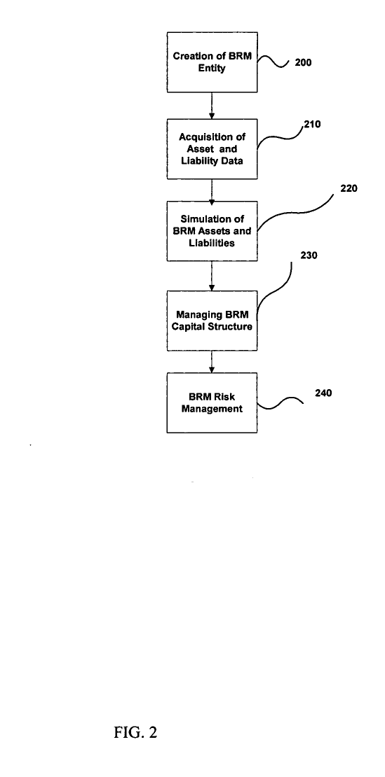

Referring now to FIG. 2, there is described the methods and systems for the management of the BRM assets and liabilities and funding or hedging such assets and liabilities. Step 200 of FIG. 2 comprised the forming of a bankruptcy remote limited liability corporation, C Corporation, asset securitization trust or similar entity. Such entity must be adequate to (i) receive a capital investment to initially support the acquisition of the BRM loans; (2) be bankruptcy remote and protected from any creditors other than the BRM obligees or debt creditors; (3) be suitable for issuing additional ownership interests so that additional capital can be raised as additional BRM assets and liabilities are acquired and (4) be suitable for the borrowing against BRM net assets or the securitization of BRM life insurance assets. In addition, the SPE of 200 of FIG. 2, or an affiliate thereof, must be considered a worthy counterparty for the purchaser's of the homes pursuant to the home mortality puts offered as part of the BRMs. BRM borrowers may be concerned about the long term creditworthiness of the promise to purchase the home from the borrower (or other specified person) upon the death of the referenced life under the mortality put.

Referring again to FIG. 2, step 210 refers to the acquisition of data with respect to the BRM liabilities and life insurance assets which comprise the balance sheet of the SPE. The BRM liabilities are both dependent upon the mortality experience of the pool of BRM borrowers and the underlying housing assets upon which the BRMs are issued (housing collateral). With respect to mortality data, the age and risk classification and current health status of each borrower, in a preferred embodiment is known. With respect to current health status, in a preferred embodiment each BRM borrower executes a HIPAA compliant medical record discovery request form which enables the manager of the SPE to periodically review the medical records of each borrower. The goal of such periodic reviews is to obtain a current conditional expected lifespan for each borrower. Any change in a given purchaser's medical condition will result in debits or credits to, in a preferred embodiment, a set of commonly used mortality tables, such as the 2001 Select Valuation Basic Tables (VBT) for Male NonSmokers. To compute the conditional life expectancy the following quantities and notation are used:

q_{t,T}=the probability of death between time t and T, conditional upon survival to time t
p_{t,T}=the probability of survival between time t and T, conditional upon survival to time t

As is commonly used, if the period of death and survival is taken to be a calendar year, the shorthand, qₜ and pₜ will be used respectively, where the second subscript, T, is implicitly understood to be equal to t+1 year. So, for example, q₆₅ is the probability that a 65 year old of a given risk class (make, nonsmoker, select) dies in the next calendar year while p₆₅ is the probability that a 65 year old of a given risk class survives in the next year. For step 210 of FIG. 2, the first substep is to acquire the qₜ for the given risk class which are available, for example, from the 2001 VBT tables. Since mortality charges are proportional to qₜ, we will assume, for sake of convenience, that the qₜ also represent the fair cost of insurance for an individual of age t in the given risk class. From the 2001 VBT tables, the qₜ for a 65 year old male nonsmoker is equal to:

TABLE 1
2001 VBT Mortality Rates for Male Nonsmokers Aged 65

| Age | Annual Mortality Rate |
|---|---|
| 66 | 0.25% |
| 67 | 0.41% |
| 68 | 0.58% |
| 69 | 0.77% |
| 70 | 0.96% |
| 71 | 1.15% |
| 72 | 1.34% |
| 73 | 1.52% |
| 74 | 1.72% |
| 75 | 2.06% |
| 76 | 2.45% |
| 77 | 2.92% |
| 78 | 3.46% |
| 79 | 4.12% |
| 80 | 4.90% |
| 81 | 5.59% |
| 82 | 6.28% |
| 83 | 7.00% |
| 84 | 7.86% |
| 85 | 8.93% |
| 86 | 10.00% |
| 87 | 11.21% |
| 88 | 12.54% |
| 89 | 13.98% |
| 90 | 15.37% |
| 91 | 18.32% |
| 92 | 19.71% |
| 93 | 21.16% |
| 94 | 22.70% |
| 95 | 24.30% |
| 96 | 25.73% |
| 97 | 27.25% |
| 98 | 28.86% |
| 99 | 30.56% |
| 100 | 32.35% |
| 101 | 34.26% |
| 102 | 36.27% |
| 103 | 38.41% |
| 104 | 40.66% |
| 105 | 43.02% |
| 106 | 45.52% |
| 107 | 48.16% |
| 108 | 50.95% |
| 109 | 53.91% |
| 110 | 57.03% |
| 111 | 60.34% |
| 112 | 63.84% |
| 113 | 67.54% |
| 114 | 71.46% |
| 115 | 75.60% |
| 116 | 79.99% |
| 117 | 84.63% |
| 118 | 89.54% |
| 119 | 94.73% |
| 120 | 100.00% |

As can be seen, the mortality charges increase with age at an increasing rate. As is known to one skilled in the art, there are relationships between the annual probabilities of death and the survival probabilities as follows:

$${p}_{t , T} = {\prod }_{i = t}^{i = T} ( 1 - {q}_{i} )$$

That is, the probability of surviving from time t to T is the product of one minus the probability of dying in each year from t to T. For the above “hazard rates” derived from the 2001 Select VBT table, the probability distribution for the death of a select 65 year old male nonsmoker (select in the sense that this individual qualifies for life insurance) is as follows:

TABLE 2
2001 VBT Mortality Distribution for Male Nonsmokers Aged 65

| | Probability of Death at |
|---|---|
| Age | Age |
| 66 | 0.25% |
| 67 | 0.41% |
| 68 | 0.58% |
| 69 | 0.76% |
| 70 | 0.94% |
| 71 | 1.12% |
| 72 | 1.28% |
| 73 | 1.44% |
| 74 | 1.60% |
| 75 | 1.88% |
| 76 | 2.20% |
| 77 | 2.55% |
| 78 | 2.94% |
| 79 | 3.38% |
| 80 | 3.86% |
| 81 | 4.18% |
| 82 | 4.44% |
| 83 | 4.63% |
| 84 | 4.84% |
| 85 | 5.06% |
| 86 | 5.17% |
| 87 | 5.21% |
| 88 | 5.18% |
| 89 | 5.05% |
| 90 | 4.77% |
| 91 | 4.81% |
| 92 | 4.23% |
| 93 | 3.65% |
| 94 | 3.08% |
| 95 | 2.55% |
| 96 | 2.05% |
| 97 | 1.61% |
| 98 | 1.24% |
| 99 | 0.93% |
| 100 | 0.69% |
| 101 | 0.49% |
| 102 | 0.34% |
| 103 | 0.23% |
| 104 | 0.15% |
| 105 | 0.09% |
| 106 | 0.06% |
| 107 | 0.03% |
| 108 | 0.02% |
| 109 | 0.01% |
| 110 | 0.00% |
| 111 | 0.00% |
| 112 | 0.00% |
| 113 | 0.00% |
| 114 | 0.00% |
| 115 | 0.00% |
| 116 | 0.00% |
| 117 | 0.00% |
| 118 | 0.00% |
| 119 | 0.00% |
| 120 | 0.00% |

In a preferred embodiment, a mortality distribution such as that of Table 2 can be used with a model of the BRM loan assets under the CPMP so that the expected net present value of the balance sheet of the BRM entity can be obtained.

Referring to FIG. 2, step 210, the liability data will comprise the (a) notional amount of BRM loans outstanding; (b) the interest rate for the BRM loans; (3) the forward interest rates expected by the interest rate market for floating rate obligations (e.g., as indicated by the Eurodollar contract prices); (4) the strike price for each BRM mortality put; (5) the volatility of forward interest rates; (6) the cost of the bundled LTC insurance; and (5) data linking each BRM loan to the mortality data of the borrower and reference life or lives under the bundled home mortality puts.

Referring again to FIG. 2, once the data for the life assets (life insurance policies on purchasers) and BRM loan assets and liabilities (home mortality puts) have been acquired, the assets and liabilities can be simulated in order to (1) first calculate the net present value of the home mortality put liabilities and (b) calculate the net asset value or surplus in the SPE in present value terms.

For ease of exposition, we will assume that there are 100 actual or prospective purchasers of mortality puts and that the average purchaser is a 65 year old nonsmoking male that is able to qualify for life insurance. The first step, following the data acquisition step of FIG. 2, 210, would be to simulate the process by which, beginning with 100 individuals, mortalities occur over an ensuring number of years, e.g., 55 years. For this cohort of individuals, the probability distribution for a 65 year sold select male nonsmoker is as follows calculated in Table 2 above.

In a preferred embodiment, standard uniform random variables can be used with the above probabilities (or using the force of mortality or hazard rates with the surviving cohort) to model the number of statistical deaths in each year. This process is repeated many times under a Monte Carlo Simulation. For example, the following Table 3 illustrates a single possible path of mortalities for the pool illustrated in Table 2:

TABLE 4
Single Monte Carlo Trail for Random Sequence
of Mortalities for 65 Year old MNS

| | | Pool | |
|---|---|---|---|
| Age | Beg in Pool | Deaths | Alive in Pool |
| 65 | 100 | 0 | 100 |
| 66 | 100 | 0 | 100 |
| 67 | 100 | 0 | 100 |
| 68 | 100 | 1 | 99 |
| 69 | 99 | 2 | 97 |
| 70 | 97 | 2 | 95 |
| 71 | 95 | 1 | 94 |
| 72 | 94 | 0 | 94 |
| 73 | 94 | 2 | 92 |
| 74 | 92 | 3 | 89 |
| 75 | 89 | 3 | 86 |
| 76 | 86 | 2 | 84 |
| 77 | 84 | 2 | 82 |
| 78 | 82 | 4 | 78 |
| 79 | 78 | 3 | 75 |
| 80 | 75 | 6 | 69 |
| 81 | 69 | 10 | 59 |
| 82 | 59 | 7 | 52 |
| 83 | 52 | 4 | 48 |
| 84 | 48 | 5 | 43 |
| 85 | 43 | 5 | 38 |
| 86 | 38 | 2 | 36 |
| 87 | 36 | 6 | 30 |
| 88 | 30 | 4 | 26 |
| 89 | 26 | 3 | 23 |
| 90 | 23 | 4 | 19 |
| 91 | 19 | 5 | 14 |
| 92 | 14 | 5 | 9 |
| 93 | 9 | 1 | 8 |
| 94 | 8 | 1 | 7 |
| 95 | 7 | 1 | 6 |
| 96 | 6 | 1 | 5 |
| 97 | 5 | 2 | 3 |
| 98 | 3 | 1 | 2 |
| 99 | 2 | 0 | 2 |
| 100 | 2 | 0 | 2 |
| 101 | 2 | 0 | 2 |
| 102 | 2 | 0 | 2 |
| 103 | 2 | 0 | 2 |
| 104 | 2 | 0 | 2 |
| 105 | 2 | 0 | 2 |
| 106 | 2 | 2 | 0 |
| 107 | 0 | 0 | 0 |
| 108 | 0 | 0 | 0 |
| 109 | 0 | 0 | 0 |
| 110 | 0 | 0 | 0 |

Another trial under the Monte Carlo process is displayed in the Table 5 below:

TABLE 5
Second Monte Carlo Trail for Random Sequence
of Mortalities for 65 Year old MNS

| | | Pool | |
|---|---|---|---|
| Age | Beg in Pool | Deaths | Alive in Pool |
| 65 | 100 | 0 | 100 |
| 66 | 100 | 0 | 100 |
| 67 | 100 | 2 | 98 |
| 68 | 98 | 1 | 97 |
| 69 | 97 | 0 | 97 |
| 70 | 97 | 1 | 96 |
| 71 | 96 | 2 | 94 |
| 72 | 94 | 0 | 94 |
| 73 | 94 | 1 | 93 |
| 74 | 93 | 1 | 92 |
| 75 | 92 | 2 | 90 |
| 76 | 90 | 2 | 88 |
| 77 | 88 | 2 | 86 |
| 78 | 86 | 2 | 84 |
| 79 | 84 | 4 | 80 |
| 80 | 80 | 4 | 76 |
| 81 | 76 | 7 | 69 |
| 82 | 69 | 9 | 60 |
| 83 | 60 | 3 | 57 |
| 84 | 57 | 5 | 52 |
| 85 | 52 | 5 | 47 |
| 86 | 47 | 7 | 40 |
| 87 | 40 | 6 | 34 |
| 88 | 34 | 6 | 28 |
| 89 | 28 | 1 | 27 |
| 90 | 27 | 9 | 18 |
| 91 | 18 | 2 | 16 |
| 92 | 16 | 5 | 11 |
| 93 | 11 | 0 | 11 |
| 94 | 11 | 3 | 8 |
| 95 | 8 | 1 | 7 |
| 96 | 7 | 3 | 4 |
| 97 | 4 | 0 | 4 |
| 98 | 4 | 1 | 3 |
| 99 | 3 | 0 | 3 |
| 100 | 3 | 0 | 3 |
| 101 | 3 | 2 | 1 |
| 102 | 1 | 0 | 1 |
| 103 | 1 | 1 | 0 |
| 104 | 0 | 0 | 0 |
| 105 | 0 | 0 | 0 |
| 106 | 0 | 0 | 0 |
| 107 | 0 | 0 | 0 |
| 108 | 0 | 0 | 0 |
| 109 | 0 | 0 | 0 |
| 110 | 0 | 0 | 0 |

The net cash flows of the life insurance policy assets which are purchased to collateralize, fund, or hedge the obligations on each BRM borrower are equal to death benefits received in each year less premiums required to be paid on the remaining surviving BRM borrowers.

For the BRM loan assets, the net present value of the BRM loans must be simulated in accordance with the above simulation of the mortalities since each BRM loan has cashflows which are contingent upon the death of the BRM borrower or borrowers. For each simulated death according the principles specified above, the cashflows under the BRM are equal to (1) minimum of the accreted BRM loan value or the market value of the house were the latter exceeds the strike price under the home mortality put; or (2) minimum of the market value of the home of the strike price under the mortality put where the home mortality put has been optimally exercised by the borrower.

Referring again to FIG. 2, step 220, the above simulation is performed many times using Monte Carlo methods. Each cashflow is discounted back to present value using the appropriate discount factor such as one based upon the length of time until the cashflow is received and the prevailing LIBOR rate to such date. The sum of these discounted cashflows, when averaged, is the discounted expected value of the value of the portfolio life insurance assets and BRM loan assets less its home mortality put liabilities. The rate at which the cashflows are discounted can be increased until the discounted expected value is equal to zero. This rate would be equal to one measure of the expected internal rate of return on the portfolio.

Referring to FIG. 2, step 230, comprises the step of receiving a rating for the SPE from one of the recognized rating agencies such at Standard and Poor's, Fitch, Moody's, or A.M. Best. Such a rating may be beneficial, in a preferred embodiment, from the standpoint of providing the BRM borrowers a measure of comfort that the SPE will be able to have sufficient resources at the time of each respective purchaser's mortality to purchase the home of the borrower pursuant to the home mortality put.

Referring to FIG. 2, step 240, the risk management of the SPE comprises a number of substeps which include (i) frequent Monte Carlo simulation of assets and liabilities as described above given current market conditions; (ii) tracking whether a BRM borrower is still alive periodically; (iii) potentially hedging, in a preferred embodiment, liability risk related to the downside exposure to the SPE of the risky assets; (iv) monitoring the credit risk of the insurance carriers that issued the life insurance policies on the BRM borrowers which are owned by the SPE; and (v) obtaining new financing for the SPE by attempting, periodically, to securitize, borrow against, or otherwise receive the present value equivalent of the future stream of cashflows to be received from the portfolio of life insurance assets and BRM assets owned by the SPE.

In the preceding specification, the present invention has been described with reference to specific exemplary embodiments thereof. Although many steps have been conveniently illustrated as described in a sequential manner, it will be appreciated that steps may be reordered or performed in parallel. It will further be evident that various modifications and changes may be made therewith without departing from the broader spirit and scope of the present invention as set forth in the claims that follow. The description and drawings are accordingly to be regarded in an illustrative rather than a restrictive sense.

What is claimed is:

1. A method, system, and financial product for efficient lifecycle investing, comprising the step of:
identifying suitable borrowers for a novel financial product called a bundled reverse mortgage, specifying the terms upon which the proceeds of the bundled reverse mortgage are to be paid, selecting a strike price for a home mortality put option to be bundled with the reverse mortgage, selection long term care insurance to be bundled with the reverse mortgage, and obtaining the consent to purchase and purchasing on the life or lives of each respective reverse mortgage borrower a policy of life insurance.
